(19) United States
(12) Patent Application Publication
(10) Pub. No.: US 2026/0319143 A1
(43) Pub. Date: Oct. 15, 2026

(54) LENS ASSEMBLY HAVING A LIQUID LENS SUPPORTED BY AN OPTICAL FILTER AND IMAGING DEVICE HAVING THE SAME

(71) Applicants: HONGFUJIN PRECISION ELECTRONS (YANTAI) CO., LTD., Yantai (CN); HON HAI PRECISION INDUSTRY CO., LTD., New Taipei (TW)

(72) Inventors: HUI-MAN WANG, New Taipei (TW); CHUN-HSIANG HUANG, New Taipei (TW)

(21) Appl. No.: 19/243,793

(22) Filed: Jun. 20, 2025

(30) Foreign Application Priority Data
Apr. 11, 2025 (CN) 202510455902.2

(51) Int. Cl. G02B 3/14

(52) U.S. Cl. CPC G02B 3/14

(57) ABSTRACT

A lens assembly includes a lens housing defining a receiving cavity and an optical through-hole along an optical axis, a liquid lens positioned within the receiving cavity and having opposed incident and exit surfaces, an optical filter disposed on the image side within the cavity and supporting the exit surface, and a driving mechanism located on a side of the incident surface away from the exit surface. The driving mechanism is configured to deform the incident surface of the liquid lens, thereby adjusting its optical power while the exit surface is stably supported by the filter. This arrangement eliminates the need for an additional rigid lens for support and allows for a more compact lens assembly along the optical axis.

### CROSS-REFERENCE TO RELATED APPLICATIONS

The present application claims the benefit and priority to Chinese Patent Application Serial No. 202510455902.2, filed on Apr. 11, 2025, and the content of which is hereby fully incorporated by reference into the present application.

### FIELD

The subject matter herein generally relates to optical imaging systems, and more particularly to a lens assembly and an imaging device having the lens assembly.

### BACKGROUND

A liquid lens can change its refractive power by changing the shape of the surface. A rigid lens may be placed on one side of the liquid lens for supporting the liquid lens. However, the use of the rigid lens increases the overall size of the lens assembly, making miniaturization more challenging.

### BRIEF DESCRIPTION OF THE DRAWINGS

Implementations of the present technology will now be described, by way of example only, with reference to the attached figures, wherein:

FIG. 1 is a cross-sectional view of an embodiment of a lens assembly.

FIG. 2 is a cross-sectional view of an embodiment of an imaging device including the lens assembly shown in FIG. 1.

### DETAILED DESCRIPTION

It will be appreciated that for simplicity and clarity of illustration, where appropriate, reference numerals have been repeated among the different FIG.s to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

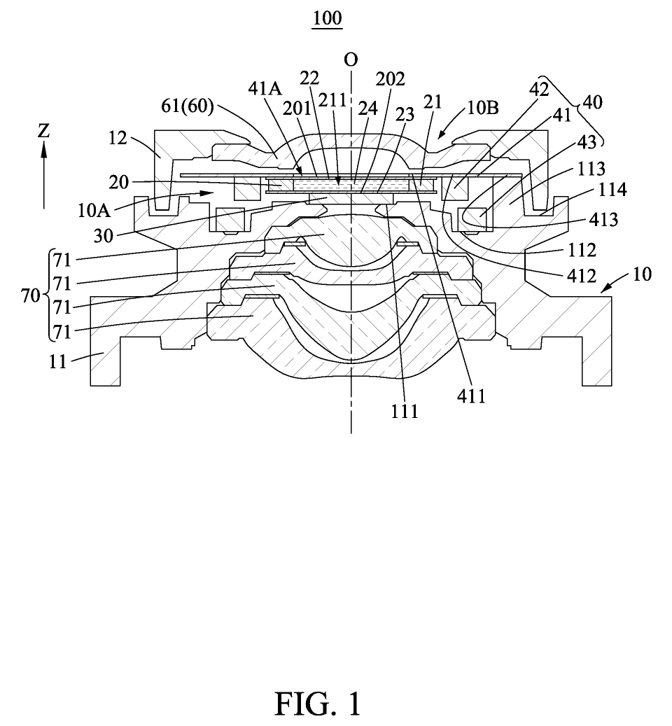

Referring to FIG. 1, a lens assembly 100 is provided according to an embodiment of the present disclosure, which has an optical axis O extending in a first direction Z. Along the first direction Z, a side facing an object is referred to as the “object side” of the lens assembly 100, and an opposite side (facing away from the object) is referred to as the “image side” of the lens assembly 100.

The lens assembly 100 includes a lens housing 10, a liquid lens 20, an optical filter 30, and a driving mechanism 40. The lens housing 10 defines an accommodating cavity 10A and an optical through hole 10B that communicates with the accommodating cavity 10A. The liquid lens 20 is disposed within the accommodating cavity 10A. The optical through hole 10B is located on the object side of the liquid lens 20 along the first direction Z.

The liquid lens 20 includes an incident surface 201 and an exit surface 202 opposite to each other along the first direction Z. The incident surface 201 is closer to the optical through hole 10B than the exit surface 202. The liquid lens 20 changes its refractive power by changing the shape of the incident surface 201 or the exit surface 202.

The optical filter 30 is disposed inside the accommodating cavity 10A on the image side of the liquid lens 20. A surface of the optical filter 30 facing the liquid lens 20 supports the exit surface 202. For example, an adhesive may be used to fix the optical filter 30 to the exit surface 202, thus providing mechanical support for the liquid lens 20.

The driving mechanism 40 is disposed within the accommodating cavity 10A. At least a portion of the driving mechanism 40 located, along the first direction Z, on the side of the incident surface 201 that is away from the exit surface 202. The driving mechanism 40 is configured to deform the incident surface 201 of the liquid lens 20. The driving mechanism 40 changes the curvature of the incident surface and hence adjusts the optical power (i.e., focal length) of the liquid lens 20.

Because the exit surface 202 is supported by the optical filter 30, the liquid lens 20 does not require a separate rigid lens on a side of the exit surface 202 for supporting purpose. As a result, the total size of the lens assembly 100 along the first direction Z can be reduced, enabling a more compact design.

In some embodiments, as shown in FIG. 1, the liquid lens 20 may include a frame 21, a first film 22, a second film 23, and a transparent liquid 24. The frame 21 defines a hollow region 211. The hollow region 211 is sealed by the first film 22 and the second film 23. The transparent liquid 24 is filled in the hollow region 211. The first film 22 forms the incident surface 201, and the second film 23 forms the exit surface 202.

In one example, the driving mechanism 40 includes a elastic plate 41, a magnet 42, and a coil 43. An end of the elastic plate 41 is fixed to the lens housing 10. A portion of the elastic plate 41 is located, along the first direction Z, on the side of the incident surface 201 away from the exit surface 202. The magnet 42 is fixed to a region of the elastic plate 41 that faces away from the incident surface 201. The coil 43 is fixed to the lens housing 10 and at least partially overlaps with the magnet 42 along the first direction Z. When the coil 43 is energized, the coil 43 generates a magnetic field that causes the magnet 42 to move along the first direction Z, thereby deforming the elastic plate 41. The deformed elastic plate 41 in turn presses against and deforms the incident surface 201, thus changing the curvature of the liquid lens 20.

The elastic plate 41 may have a first through hole 41A coaxial with the optical through hole 10B, thereby preventing the elastic plate 4 from blocking the light. In a direction perpendicular to the first direction Z, the elastic plate 41 can include a first portion 411, a second portion 412, and a third portion 413 each surrounding the first through hole 41A. The first portion 411, the second portion 412, and the third portion 413 are sequentially connected to each other. The first portion 411 is located closest to the incident surface 201, the second portion 412 supports the magnet 42, and the third portion 413 is fixed to the lens housing 10.

In some embodiments, the lens housing 10 includes a first base 11 and a second base 12. The first base 11 includes a first recess 111, a second recess 112, a first protrusion 113, and a third recess 114. In the direction perpendicular to the first direction Z, the first recess 111, the second recess 112, the first protrusion 113, and the third recess 114 are arranged in sequence from inside to outside. The first recess 111 supports the optical filter 30 and defines a second through hole 111A coaxial with the optical through hole 10B. The second recess 112 supports the coil 43. The first protrusion 113 fixes the third portion 413 of the elastic plate 41. The third recess 114 supports the second base 12. The accommodating cavity 10A is formed between the first base 11 and the second base 12, and the optical through hole 10B is formed in the second base 12.

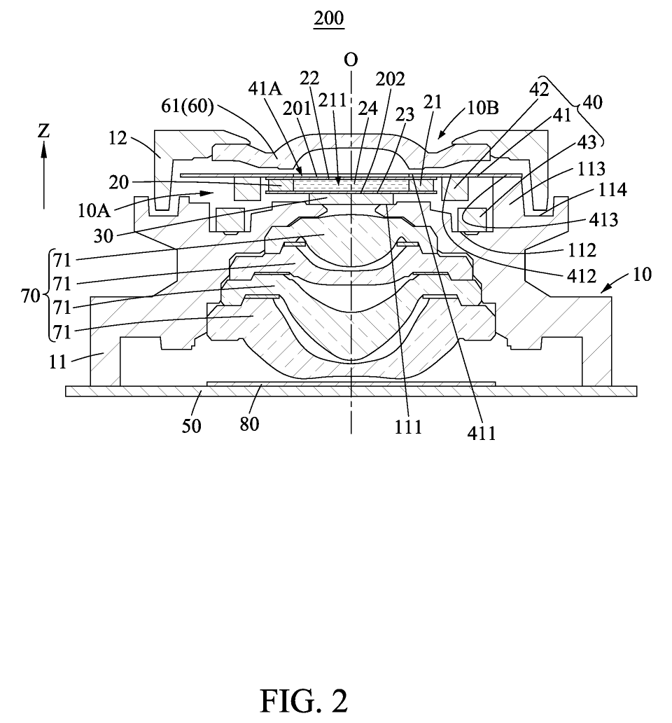

In some embodiments, as shown in FIG. 2, the lens assembly 100 may include a circuit board 50 disposed outside the lens housing 10. The coil 43 may be electrically connected to the circuit board 50 via a conductive silver paste or other suitable electrical conductors.

Additionally, the lens assembly 100 may include a first lens group 60 on the object side of the liquid lens 20. The first lens group 60 may comprise at least one lens element 61 that cooperates with the liquid lens 20 to provide the desired optical power. The lens assembly 100 can further include a second lens group 70 on the image side of the liquid lens 20, which may comprise at least one lens element 71, and can be fixed or movable along the first direction Z.

Referring to FIG. 2, an imaging device 200 can be formed by combining the lens assembly 100 with an image sensor 80 (for instance, a CCD or CMOS sensor). The image sensor 80 is positioned along the first direction Z on the image side of the optical filter 30. Light passing through the lens assembly 100 is detected by the image sensor 80 to produce images.

By providing an actuator mechanism to deform the incident surface 201 of the liquid lens 20 while the exit surface 202 is supported by the optical filter 30, the lens assembly can achieve focus adjustment without the need of an additional rigid lens for supporting the liquid lens 20. This allows the lens assembly 100 to be made thinner along the optical axis, facilitating miniaturized designs.

The embodiments shown and described above are only examples. Many details are often found in the art such as the other features of the lens assembly 100. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A lens assembly having an optical axis extending in a first direction, and comprising:
a lens housing defining an accommodating cavity and an optical through hole communicating with the accommodating cavity;
a liquid lens disposed in the accommodating cavity, the liquid lens comprising an incident surface and an exit surface opposite to each other along the first direction, wherein the incident surface is located closer to the optical through hole than to the exit surface;
an optical filter disposed in the accommodating cavity on an image side of the liquid lens along the first direction, wherein a surface of the optical filter facing the liquid lens supports the exit surface; and
a driving mechanism disposed in the accommodating cavity, wherein at least a portion of the driving mechanism is located on a side of the incident surface away from the exit surface along the first direction, the driving mechanism is configured to deform the incident surface.

2. The lens assembly of claim 1, wherein the liquid lens further comprises:
a frame defining a hollow region;
a first film and a second film secured on opposite sides of the frame along the first direction, the first film forming the incident surface, and the second film forming the exit surface; and
a transparent liquid sealed within the hollow region.

3. The lens assembly of claim 1, wherein the driving mechanism comprises:
an elastic plate having an end fixed to the lens housing, wherein at least a portion of the elastic plate is located on a side of the incident surface away from the exit surface along the first direction;
a magnet fixed to a region of the elastic plate away from the incident surface; and
a coil fixed to the lens housing and at least partially overlapping with a projection of the magnet along the first direction.

4. The lens assembly of claim 3, wherein when the coil is energized, a magnetic field is generated and the magnet is moved along the first direction, thereby deforming the elastic plate, and the deformed elastic plate is configured to press against the incident surface to change a curvature of the elastic plate.

5. The lens assembly of claim 3, wherein the elastic plate defines a first through hole coaxial with the optical through hole, the elastic plate comprises a first portion, a second portion, and a third portion, the first portion, the second portion, and the third portion are sequentially connected to each other in a direction perpendicular to the first direction, the first portion, the second portion, and the third portion are arranged outside the first through hole, the first portion is located on the side of the incident surface away from the exit surface along the first direction, the second portion is fixed to the magnet, and the third portion is fixed to the lens housing.

6. The lens assembly of claim 5, wherein the lens housing comprises a first base and a second base, the first base comprises a first recess, a second recess, a first protrusion, and a third recess sequentially arranged from inside to outside in a direction perpendicular to the first direction;
the first recess supports the optical filter along the first direction and defines a second through hole coaxial with the optical through hole;
the second recess supports the coil;
the first protrusion fixes the third portion of the elastic plate; and
the third recess supports the second base,
wherein the accommodating cavity is formed between the first base and the second base, and the second base defines the optical through hole.

7. The lens assembly of claim 3, further comprising a circuit board disposed outside the lens housing, wherein the coil is electrically connected to the circuit board.

8. The lens assembly of claim 1, further comprising a first lens group comprising at least one lens element, wherein the first lens group is connected to the lens housing on an object side of the liquid lens along the first direction.

9. The lens assembly of claim 1, further comprising a second lens group comprising at least one lens element, wherein the second lens group is connected to the lens housing on an image side of the liquid lens along the first direction.

10. An imaging device, comprising:
a lens housing defining an accommodating cavity and an optical through hole communicating with the accommodating cavity;
a liquid lens disposed in the accommodating cavity, the liquid lens comprising an incident surface and an exit surface opposite to each other along the first direction, wherein the incident surface is located closer to the optical through hole than to the exit surface;
an optical filter disposed in the accommodating cavity on an image side of the liquid lens along the first direction, wherein a surface of the optical filter facing the liquid lens supports the exit surface; and
a driving mechanism disposed in the accommodating cavity, wherein at least a portion of the driving mechanism is located on a side of the incident surface away from the exit surface along the first direction, the driving mechanism is configured to deform the incident surface; and
an image sensor arranged on the image side of the optical filter.

11. The imaging device of claim 10, wherein the liquid lens further comprises:
a frame defining a hollow region;
a first film and a second film secured on opposite sides of the frame along the first direction, the first film forming the incident surface, and the second film forming the exit surface; and
a transparent liquid sealed within the hollow region.

12. The imaging device of claim 10, wherein the driving mechanism comprises:
an elastic plate having an end fixed to the lens housing, at least a portion of the elastic plate being located on a side of the incident surface away from the exit surface along the first direction;
a magnet fixed to a region of the elastic plate away from the incident surface; and
a coil fixed to the lens housing and at least partially overlapping with a projection of the magnet along the first direction.

13. The imaging device of claim 12, wherein when the coil is energized, a magnetic field is energized, and the magnetic field is moved along the first direction, thereby deforming the elastic plate, and the deformed elastic plate is configured to press against the incident surface to change a curvature of the elastic plate.

14. The imaging device of claim 12, wherein the elastic plate defines a first through hole coaxial with the optical through hole, the elastic plate comprises a first portion, a second portion, and a third portion, the first portion, the second portion, and the third portion are sequentially connected to each other in a direction perpendicular to the first direction, the first portion, the second portion, and the third portion are arranged outside the first through hole, the first portion is located on the side of the incident surface away from the exit surface along the first direction, the second portion is fixed to the magnet, and the third portion is fixed to the lens housing.

15. The imaging device of claim 14, wherein the lens housing comprises a first base and a second base, the first base comprises a first recess, a second recess, a first protrusion, and a third recess sequentially arranged from inside to outside in a direction perpendicular to the first direction;
the first recess supports the optical filter along the first direction and defines a second through hole coaxial with the optical through hole;
the second recess supports the coil;
the first protrusion fixes the third portion of the elastic plate; and
the third recess supports the second base,
wherein the accommodating cavity is formed between the first base and the second base, and the second base defines the optical through hole.

16. The imaging device of claim 12, wherein the lens assembly further comprises a circuit board disposed outside the lens housing, the coil is electrically connected to the circuit board.

17. The imaging device of claim 10, wherein the lens assembly further comprises a first lens group, the first lens group comprises at least one lens element, the first lens group is connected to the lens housing on an object side of the liquid lens along the first direction.

18. The imaging device of claim 10, wherein the lens assembly further comprises a second lens group, the second lens group comprises at least one lens element, the second lens group is connected to the lens housing on an image side of the liquid lens along the first direction.
